(19) United States
(12) Patent Application Publication
(10) Pub. No.: US 2007/0022911 A1
(43) Pub. Date: Feb. 1, 2007

(54) Method of manufacturing luminescent tiles and products made therefrom

(75) Inventors: Fred Horton JR., Pt. St. John, FL (US); Robert Howard Kari, Ocoee, FL (US)

Correspondence Address: AKERMAN SENTERFITT, P.O. BOX 3188, WEST PALM BEACH, FL, 33402-3188, US

(73) Assignee: C.L. Industries, Inc., Orlando, FL (US)

(21) Appl. No.: 11/194,174

(22) Filed: Aug. 1, 2005

(51) Int. Cl. C09K 11/02; C09K 11/08; C04B 28/26; C04B 12/04; C04B 14/12; C04B 16/08; C04B 35/16; C04B 38/00

(52) U.S. Cl. 106/602; 252/301.36; 252/301.4 F; 252/301.6 F; 252/301.4 R; 252/301.6 R

(57) ABSTRACT

A method of manufacturing a luminescent tile for use in an aqueous environment includes admixing a luminescent pigment capable of being illuminated by an external light source, a forming material, and a catalyst to create a luminescent mixture. Casting the luminescent mixture into a mold and allowing said mixture to substantially harden thereby creating a luminescent tile. The forming material permits luminescence from the luminescent pigment upon excitation by an external light source, such as, a blacklight, while allowing the luminescent pigment to be safely used in an aqueous environment, such as a pool, spa, or the like.

### FIELD OF THE INVENTION

The present invention relates generally to the manufacture of luminescent tiles and more specifically to the manufacture of luminescent tiles for use in an aqueous environment.

### BACKGROUND OF THE INVENTION

Man-made aqueous environments such as pools, spas, aquariums, ponds and the like often comprise lights to illuminate the aqueous environment. These lights can be submerged in the environment, particularly embedded in a wall of the pool, spa or the like, or directed at the environment. The lights can be used either to illuminate the pool, spa or the like during use, or to give a decorative effect at night or at other times when the pool, spa or the like is not in use. In addition, the lights can comprise numerous colors and shades to provide a desired effect to the aqueous environment.

One alternative to standard electric lighting is the use of luminescent compounds, which may be incorporated into walls and artificial stones to create a decorative effect. Luminescent compounds create a glowing light without consuming excessive amounts of electricity or generating excessive amounts of heat. Luminescent compounds are excited to emit light by certain wavelengths of electromagnetic radiation, generally ultraviolet light (UV).

Prior attempts have been made to create decorative effects using luminescent compounds. These environments generally comprise luminescent pigments that are added directly into the substrate which they are intended to illuminate. However, the luminescent compounds do not provide a good decorative effect in aqueous environments because the luminescent compounds tend to dissolve in water.

U.S. Pat. No. 6,818,153 to Burnell-Jones discloses the addition of luminescent pigment into the gel coat layer of a fiber glass article, such as a pool shell to create a continuous luminescent substrate. Fillers are added to reinforce the gel coat and provide the underlying fiberglass with the requisite strength to retain its shape and contents. These gel coats are not particles and use fillers that hinder the formation of particles from the gel coats.

U.S. Pat. No. 6,596,074 to Pomeroy discloses the addition of a luminescent compound to an aggregate such as concrete or mortar. The patent teaches the addition of a luminescent pigment directly into an aggregate mixture. In application, such a mixture is not effective as the luminescent compound is diluted among the aggregate and its luminescent qualities are diminished. Accordingly, there is a reduced or no luminescent effect in the underlying aggregate.

Attempts have been made to create ceramic tiles using luminescent compounds. Japanese Patent Application Publication Number JP11172941 to Saituo Kazuo discloses ceramic luminescent tiles. Luminescent compounds are applied to the surface of a ceramic tile, after which the tile is baked to cure and adhere the luminescent compound to the tile. Drawbacks to tiles created by ceramic manufacturing processes are the brittle nature of the resulting tile, as well as the time and energy required to yield a finished product.

The documents and publications cited in this disclosure are incorporated by reference in their entirety, to the extent they are not inconsistent with the explicit teachings set forth herein.

It would be beneficial to provide a method of manufacturing a luminescent tile that can be capable of being effectively used in an aqueous environment. It would also be beneficial to provide method of manufacturing a luminescent tile that does not require the application of high heat resulting in increased energy consumption and cost. It would also be beneficial to provide a luminescent tile that can include both colored pigment and luminescent pigment to provide decorative effects in aqueous environments in both the daylight and dark.

### SUMMARY OF THE INVENTION

Accordingly, it is an object of the present invention to provide a method of manufacturing a luminescent tile. More specifically, it is an object of the present invention to provide a method of manufacturing a luminescent tile for use in an aqueous environment.

Aspects of the invention include a method of manufacturing a luminescent tile that includes admixing a forming material, a luminescent pigment and a catalyst to create a luminescent mixture; casting the mixture into a shaped mold; and allowing the mixture to harden and create a luminescent tile having the shape of the mold.

Aspects of the invention further contemplate a method of manufacturing luminescent tiles that includes adding a colored pigment to the luminescent mixture for creating a tile that can show color in daylight.

Aspects of the invention further contemplate a method of manufacturing luminescent tiles that includes adding a UV stabilizer to prevent UV degradation.

Aspects of the invention further contemplate a method of manufacturing luminescent tiles that includes using the tiles in an aqueous environment, such as, for example, a pool, a spa, an aquarium, a fountain, or a pond.

Aspects of the invention further contemplate luminescent pigment that emit light upon excitation by light in the UV range of the electromagnetic radiation spectrum. Such UV light can be produced by a blacklight.

The forming material may be resins, silicates, quartz, or a combination thereof.

Aspects of the present invention further contemplate a tile having luminescent characteristics formed by admixing a luminescent pigment with a forming material to create a substantially homogenous mixture. Admixing a catalyst to the mixture and casting the mixture in a mold wherein the catalyst chemically reacts with the mixture to create a luminescent tile. The method can include admixing colored pigments for additional color and UV stabilizers to prevent UV degradation.

Aspects of the invention also include method of using a luminescent tile in an aqueous environment that includes obtaining a luminescent tile, wherein the tile comprises a resin, a luminescent pigment, and a catalyst, and forming a substrate using the luminescent tile and a substrate material.

### DETAILED DESCRIPTION OF THE INVENTION

Luminescent compounds emit light that does not derive energy from the temperature of the emitting body, which may be due to phosphorescence, fluorescence, or bioluminescence. Luminescence is caused by chemical, biochemical, or crystallographic changes, the motion of subatomic particles, or radiation-induced excitation of an atomic system. Phosphorescence is the persistent emission of light following exposure to and removal of incident radiation. Fluorescence is the emission of light or other radiation, stimulated in a substance by the absorption of incident radiation and persisting only as long as the stimulating radiation is continued. Commercial examples of luminescent pigments sold in varying colors are those available under the Lumilux® brand of pigments produced by Honeywell. The Lumilux® pigments are particularly well suited for the present invention. Suitable pigments such as those available under the Lumilux® brand include alkaline earth aluminates such as calcium aluminate and strontium aluminate, which may or may not be doped with other elements.

Aspects of the present invention contemplate methods for manufacturing luminescent tiles for use in aqueous environments. The luminescent tiles, in one embodiment, can include a luminescent pigment, a forming material and a catalyst. By way of example, the luminescent pigment, such as Lumilux® and the like, may be admixed with a forming material, such as resin and a catalyst to create a mixture. After the mixture is formed it is molded into the desired shape of the tile and allowed to harden.

When a tile has substantially hardened, it can be adhered to a surface wherein a substrate material such as, for example, cement, mortar or grout is applied around the luminescent tile to create a surface wherein the luminescent tile is visible within the substrate material. The luminescent tile can be positioned substantially flush with the surface of the surrounding substrate material or can be positioned such that the tile is raised above or recessed below the surface of the surrounding substrate material. Due to the fact that the luminescent pigments are suspended and encapsulated within the forming material, and thus protected from dissolving in any surrounding water, the luminescent tiles are especially useful in aqueous environments including, but not limited to, pools, spas, fountains, aquariums or ponds.

The molding process generally comprises introducing the luminescent mixture into a shaped mold made from a non-adhering material or a material capable of being covered or coated with a non-adhering material. Non-adhering materials are desired because they allow release of the tile from the mold after casting and hardening. The mixture is allowed to substantially harden, and is then removed from the mold in the form of a tile. The mixture is substantially hardened when it is capable of being removed from the mold and substantially retain its shape. Molding processes contemplated herein include cast molding, injection molding or any other molding process as is known in the art.

Tiles of different shapes and sizes may be used in various mixture configurations to provide a wide variety of luminescent effects. Tiles can be cast in molds to give the tiles the desired shapes. Desired shapes can include geometric shapes, abstract shapes, animal shapes, plant shapes, tree shapes, flower shapes, astronomical shapes, mascot shapes, mosaic shapes or any other shape capable of being molded as disclosed herein. Marine mammal, fish, and aquatic plant shapes are particularly appealing when used in aqueous environments. For example, the tiles may be formed in the shape of dolphins, turtles, fish and water lily shapes.

To create the appropriate wavelength of light, special lights, or lights comprising special filters can be used to provide the excitation radiation, or natural daylight may be used. For example, a blacklight can be used. Blacklights are fluorescent or incandescent lamps that can emit UV light and can cause phosphorescent or fluorescent compounds to illuminate. Because blacklights generally emit only faint light in the visible part of the electromagnetic spectrum, and typically emit a purple visible light, it is difficult for a person to see the excitation with the naked eye. Most of the light emitted by a blacklight is UV radiation that cannot be seen with the naked eye. The illumination of a phosphorescent or fluorescent compound with a blacklight thus creates a glowing effect without a user being aware of the lighting used for excitation. This creates a particularly pleasing decorative effect at night.

In addition to the luminescent pigment, the luminescent tiles of the present invention also include forming material which generally comprises a substantial portion of the composition of the tile. As used herein a “forming material” is any material in which a luminescent pigment can be included while permitting luminescence from the luminescent pigment to be viewed in an aqueous environment. As such, in select embodiments of the present invention, the forming material is a substantially transparent and/or translucent material. Examples of forming materials that may be used in the present invention include, but are not limited to silicates (including glass), quartz, resins, or a combination thereof. When hardened, the forming material substantially maintains the shape and form of the cast tile.

Resins are classes of solid, semi-solid or liquid organic products of natural or synthetic origin, generally of high molecular weight with no definite melting point. When catalyzed, the resin cures by undergoing a polymerization process, transforming the resin into a solid. Resins may be used in the present invention to surround and hold the luminescent pigment to form solid compositions. Many resins are translucent and/or transparent. Examples or resins useful in the present invention include, but are not limited to, acrylics, alkyds, copal esters, epoxies, polyurethanes, polyesters, polyvinyl chlorides, silicones, vinyls, vinyl esters, or any other resin capable of suspending a luminescent pigment.

If a resin is used as the forming material, then a catalyst may be used to assist in the formation of the luminescent tiles. Catalysts, also known as resin activators or hardeners, are substances that increase the rate of chemical reactions without being consumed in the reactions. Catalysts may be used to lower the activation energy for a chemical reaction by providing an alternate pathway for the reaction. Example of catalysts that may be used in the present invention include, but are not limited to, vinylbenzene, di-vinylbenzene or any other catalyst or resin activator capable of polymerizing a luminescent/resin mixture to create a substantially solid composition.

Aspects of the present invention contemplate luminescent tiles comprising: up to 96% forming material; up to 20% luminescent pigment; and up to 15% catalyst. Additional embodiments contemplate luminescent tiles further comprising up to 5% colored pigment and/or up to 10% UV stabilizer.

In alternative embodiments, an ultraviolet stabilizer may be added to the mixture at any time prior to casting the luminescent tile to maintain the integrity of the tile when exposed to UV light and prevent premature degradation caused by such exposure. In alternative embodiments, more than one UV stabilizer may be used.

The luminescent tiles are, in one embodiment, substantially solid. The tiles may be formed by mixing the luminescent pigment with the forming material, such as resin, together with any other compounds that are desired, such as colored pigments, UV stabilizers or any other desired compounds.

Substrate materials that may be used in the present invention include, but are not limited to, concrete, mortar, grout and the like. Substrate materials generally include cement in addition to additives, such as lime, sand, marble, rock, clay, kaolin, silica, calcium, magnesium, polyester, polyethylene, as well as commercial additives, such as Marble XO, Marble CP Filler, Optiwhite, Hi-Fibe 254, NYAD-G, RP 226, RP 245, Colored Aggregate Blue, Metastar, Easyspred, Super Air Plus, Clay Thickener 40, or any combination thereof. The tile compound can be added to a mold containing the substrate mixture (or vice versa) prior to setting the tile. Because of the nature of the tile compound, in which the luminescent pigment is effectively encapsulated there is no need to specially treat the substrate prior to the addition of the tile compound.

Aspects of the invention contemplate colored luminescent tiles and can also include luminescent tiles that are generally white in color, under normal conditions, that will blend with the surrounding substrate material to create a surface that is substantially uniform in color. When the tiles are excited by an external light source emitting the appropriate wavelength of light, the tiles themselves then emit light in a color consistent with the color of the luminescent pigment used therein. For example, under normal lighting conditions the surface of a pool could have a substantially uniform white surface. Once the appropriate external light source is applied to the surface of the pool, the luminescent tile could begin to emit, for example, a yellow color light in the shape or pattern of the tiles.

Once the tile is sufficiently set, the surface can be treated to more fully expose a surface of the luminescent tiles, while allowing the tiles to remain in place. The greater the amount of the surface area of the luminescent material that is exposed, the greater amount of light it will emit. To properly treat the surface of the tiles, they may be acid washed with muriatic acid or other acid as is known in the pool finishing art to remove any excess substrate materials from the surface of the tiles. In another embodiment, the surface of the tiles can be ground with an abrasive as is known in the pool finishing art to remove excess materials and more fully expose the surface of the tiles.

### EXAMPLES

### Example 1

Luminescent Tile Composition

| | |
|---|---|
| About 83% | polyester casting resin |
| About 11% | Lumilux ® luminescent pigment |
| About 5% | vinylbenzene (styrene) catalyst |
| About 0.3% | color pigment |

Example 1 represents a formulation of the underlying luminescent composition according to aspects of the present invention.

Polyester resin is measured to yield a tile comprising about 83% by weight polyester resin. Colored pigment is measured and admixed to the resin to yield a tile comprising about 0.3% by weight colored pigment. It will be appreciated that the percentages given in Example 1 are exemplary only, and can be increased or decreased by up to 15% for each component. The resulting composition is mixed for about two minutes. Luminescent pigment is measured and admixed to yield a tile comprising about 11% by weight luminescent pigment. The resulting composition is mixed for approximately two minutes. Sufficient colored pigments and luminescent pigments can be added to yield a colored tile during daylight hours and a luminescent tile when properly activated or excited. Prior to casting the tile in a mold, a catalyst is admixed to yield a tile comprising about 5% by weight catalyst. The resulting composition is mixed for about one minute then cast into a non-adhering mold wherein it hardens for about ninety minutes before it is removed from the mold. When sufficiently hardened the composition comprises a luminescent tile that can be installed in a substrate and used in an aqueous environment.

The preceding disclosure presents the best mode devised by the inventor for practicing the invention and is intended to enable one skilled in the pertinent art to carry it out, it is apparent that methods incorporating modifications and variations will be obvious to those skilled in the art. As such, it should not be construed to be limited thereby but should include such aforementioned obvious variations and be limited only by the spirit and cope of the following claims. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of.”

What is claimed is:

1. A method of manufacturing a luminescent tile comprising:
admixing a forming material, a luminescent pigment and a catalyst to create a luminescent mixture;
casting said mixture into a shaped mold; and
allowing said mixture to harden to create a luminescent tile comprising the shape of said mold.

2. The method of manufacturing a luminescent tile of claim 1, wherein said luminescent mixture further comprises at least one colored pigment.

3. The method of manufacturing a luminescent tile of claim 1, wherein said mixture further comprises a UV stabilizer.

4. The method of manufacturing a luminescent tile of claim 1, wherein said tile is usable in an aqueous environment.

5. The method of manufacturing a luminescent tile of claim 4, wherein said aqueous environment is a pool, a spa an aquarium, a fountain, or a pond.

6. The method of manufacturing a luminescent tile of claim 1, wherein said luminescent pigment emits light upon excitation by light in the UV range of the electromagnetic radiation spectrum.

7. The method of manufacturing a luminescent tile of claim 6, wherein said UV light is produced by a blacklight.

8. The method of manufacturing a luminescent tile of claim 1, wherein said forming material is selected from resins, silicates, glass, quartz, or a combination thereof.

9. A tile having luminescent characteristics formed by admixing a forming material, a luminescent pigment and a catalyst to create a luminescent mixture; casting said mixture into a shaped mold; and allowing said mixture to harden to create a luminescent tile comprising the shape of said mold.

10. The tile of claim 9, wherein said luminescent mixture further comprises at least one colored pigment.

11. The tile of claim 9, wherein said mixture further comprises a UV stabilizer.

12. The tile of claim 9, wherein said tile is usable in an aqueous environment.

13. The tile of claim 12, wherein said aqueous environment is a pool, a spa, an aquarium, a fountain, or a pond.

14. The tile of claim 9, wherein said luminescent pigment emits light upon excitation by light in the UV range of the electromagnetic radiation spectrum.

15. The tile of claim 14, wherein said UV light is produced by a blacklight.

16. The tile of claim 9, wherein said forming material is selected from resins, silicates, glass, quartz, or a combination thereof.

17. The tile of claim 9, wherein said luminescent mixture is substantially homogeneous.

18. A method of using a luminescent tile in an aqueous environment comprising:
obtaining a luminescent tile;
obtaining a substrate material; and
forming a substrate by adhering said tile and said substrate material to a surface where said tile is visible within said substrate material.

19. The method of claim 18, wherein said luminescent tile comprises a UV stabilizer.

20. The method of claim 18, wherein said luminescent tile comprises a color substantially similar to the color of the surrounding substrate material.

21. The method of claim 18, wherein said luminescent tile is colored.

22. The method of claim 18, wherein said tile and substrate material are substantially flush.

23. The method of claim 18, wherein said tile is raised above the surface of said substrate material.

24. The method of claim 18, wherein said tile is locatable in an aqueous environment.

25. The method of claim 24, wherein said aqueous environment is selected from the group consisting of: a pool; a spa; an aquarium; a fountain and a pond.

26. The method of claim 18, wherein said luminescent pigment emits light upon excitation by light in the UV range of the electromagnetic radiation spectrum.

27. The method of claim 26, wherein said UV light is produced by a blacklight.

28. The method of claim 18, wherein said substrate material is comprised of cement and at least one other material selected from the group consisting of: lime; sand; marble; rock; clay; kaolin; silica; calcium; magnesium; polyester; polyethylene, or any combination thereof.
